(19) United States
(12) Patent Application Publication
(10) Pub. No.: US 2012/0141663 A1
(43) Pub. Date: Jun. 7, 2012

(54) Quinhydrone-containing Sensor

(76) Inventors: Wolfgang G. Schoeppel, Neuss (DE); Silke D. Mechernich, Dusseldorf (DE); Jens Bichel, Meerbusch (DE)

(21) Appl. No.: 13/384,656

(22) PCT Filed: Aug. 12, 2010
(86) PCT No.: PCT/US10/45281

§ 371 Date: Jan. 18, 2012

Related U.S. Application Data
(60) Provisional application No. 61/235,969, filed on Aug. 21, 2009.

(51) Int. Cl. B05D 5/12; C09D 11/00; B05D 3/00; C08L 1/28

(52) U.S. Cl. 427/58; 106/501.1; 106/31.13; 106/31.92

(57) ABSTRACT

The application relates to quinhydrone (RN=106-34-3) containing sensors (10) for e.g. potentiometric measurements, especially in vivo measurements such as potentiometric pH measurements in wounds. In particular, the application describes methods for preparing crystalline quinhydrone for use as an ink in the manufacture of such sensors. By combining concentrated aqueous solutions of benzoquinone and hydroquinone in the presence of a water soluble polysaccharide derivative, especially hydroxypropyl methyl cellulose (HPMC), crystals of quinhydrone are obtained which are characterised by a low aspect ratio (<2.5). This renders them especially advantageous for use in pH electrodes.

### FIELD

The invention relates to quinhydrone containing sensors for e.g. potentiometric measurements, in particular in vivo measurements, such as potentiometric pH measurement in wounds. Additionally this invention relates to advantageous processes for preparing quinhydrone materials for use in or as a quinhydrone ink in the manufacture of such sensors, methods of manufacture such sensors, as well as crystalline quinhydrone materials having desirable properties.

### BACKGROUND

Quinhydrone is a 1:1 charge-transfer-complex of para-benzoquinone and hydroquinone. Ullmans Encyclopedia of Technical Chemistry reports that quinhydrone is obtained from the two components in acetic acid solution. In laboratory experiments, quinhydrone may be produced by the combination of the two components in organic solvents and/or water or, alternatively through reaction of hydroquinone with Fe(III)chloride. Quinhydrone is isolated as long, thin needles.

Quinhydrone is long known to find application in the so-called quinhydrone electrode, i.e. a redox electrode consisting of an inert metal, such as a platinum wire, in a saturated solution of quinhydrone for e.g. pH potentiometric measurements. This conventional quinhydrone electrode, although described in just about all textbooks on electroanalysis, is nowadays essentially only of historic interest. It has been reported for example in Electroanalysis 1995, 7, no. 9, 889-894 (Düssel et al.) that among its limitations the main reason for the common dislike of this electrode is its disadvantageous handling.

For at least the last thirty years, dry (e.g. not stored wet, nor pre-wetted prior to use) working electrodes for pH measurements which contain or may contain quinhydrone have been described in a number of documents, including e.g. U.S. Pat. No. 4,214,968 (Battaglia et al.); WO 88/04048 (Birch et al.); JP9222414 (Goto Masao, Nok Corp); and DE 101 08 539 (DPAT Behnert GmbH); and Chemistry of Materials 1996, 8, 2579-2585 (Aquino-Binag et al.).

Despite such activity over a long period of time, to our knowledge no pH sensor based on a dry, quinhydrone-containing electrode has been successfully commercialized.

### SUMMARY OF THE INVENTION

It has been found that the issues in providing a commercially feasible and desirable dry sensor based on quinhydrone seem to be multi-fold, ranging from being able to achieve appropriate response times to being able provide working electrodes of an appropriate size to being able to achieve large scale manufacturability.

Surprisingly it has been found that the use of at least one water soluble derivative of a polysaccharide in conjunction with quinhydrone allows for the provision of working electrodes having advantageous properties for disposable pH sensors.

Accordingly in one aspect of the present invention there is provided a disposable pH sensor including a dry working electrode formed at least in part of a sensing composition comprising quinhydrone and at least one water soluble derivative of a polysaccharide.

The predominant advantage of such a working electrode is that upon contact of the dry/dried sensing composition with an aqueous-based sample, such as wound fluid, blood, urine, or saliva, essentially all of the quinhydrone within the electrode becomes available for measurement. In other words the electrode is essentially a “depth” electrode rather a “surface” electrode. Other advantages of such a depth electrode include reduced sensitivity to radiation in sterilization (typically necessary for in-vivo measurement applications), generally no need to condition or pre-condition (such as grinding the surface) the electrode (thus allowing for cost-effective, large scale manufacture of thin electrode layers), generally no need (nor is it generally desirable) to mix a conductive component into sensing composition, and, finally allowance of fast response times.

The provision of such a depth electrode is particularly surprising in that the electrode remains essentially physically stable, i.e. there is no substantial dissolution of the electrode, and in particular without cross-linking the at least one water soluble derivative of a polysaccharide, and without including hydrophobic polymers (such as polyurethanes, polydienes, polyolefins, polysiloxanes, polyorganophosphazenes, etc.) e.g. as an adhesive material into the sensing composition. Without being bound to any particular theory, it seems that the electrode remains essentially physically stable due to a combination of physical adsorption and some type of specific interaction between quinhydrone and the at least one water soluble derivative of a polysaccharide.

The use of at least one water soluble derivative of a polysaccharide is also advantageous in the preparation of crystalline quinhydrone, in particular firstly in the preparation of crystalline quinhydrone dispersions having favorable viscosities and low tendencies towards sedimentation, both useful properties for quinhydrone-inks and advantageous for easy and reproducible fabrication of electrodes and sensors, and secondly in the preparation of crystalline quinhydrone materials having desirable particle properties.

Accordingly other aspects of the present invention include:

A method of preparing crystalline quinhydrone suitable for use in or as a quinhydrone ink in the manufacturing of a sensor, said method comprising a step of combining aqueous solutions of benzoquinone and hydroquinone in the presence of at least one additive, wherein the concentration of the aqueous solutions of benzoquinone and hydroquinone are such that the concentration of quinhydrone formed upon said combining exceeds the solubility of quinhydrone at the temperature at which said combining is performed and wherein the at least one additive is at least one water soluble derivative of a polysaccharide.

A method of preparing a quinhydrone ink for use in the manufacturing of a sensor, said method comprising the steps of providing crystalline quinhydrone according to aforesaid method; allowing the crystalline quinhydrone to sediment; removing part or all of the supernatant; and adding a liquid to the sediment and dispersing the sediment in said liquid.

A method of preparing a sensor, said sensor comprising a substrate provided with at least one conductive path, the method comprising a step of forming a working electrode, said step of forming comprising depositing and drying a product of either one of the aforesaid methods onto a conductive electrode base that is provided on the substrate and in electrical contact with the conductive path, or, if such a product is further provided with a conductive component, said step of forming comprising depositing and drying the product onto the substrate such that the formed working electrode is in electrical contact with said conductive path provided on the substrate.

In favorable embodiments of the second listed method, the liquid comprises at least one modifier, more favorably at least one water soluble derivative of a polysaccharide. In such favorable embodiments the at least one water soluble derivative of a polysaccharide used as modifier may or may not be the same as the at least one water soluble derivative of a polysaccharide used as additive in method of preparing crystalline quinhydrone.

As indicated above the first listed method is beneficial in providing directly a product for use in or as a quinhydrone ink useful for manufacture of electrodes, where crystalline quinhydrone is generated in situ. Furthermore the first listed method advantageously provides crystalline quinhydrone materials (e.g. aqueous dispersions thereof) having desirable particle properties, in particular squared or globular-like crystalline particles.

Accordingly an additional aspect of the present invention is the provision of crystalline quinhydrone characterized in that 90% or more of the particles have an aspect ratio equal to or less than 2.5.

Such crystalline quinhydrone is advantageous for use in electrodes due to desirable stability (e.g. over aging) as a result of high number of particles of the crystalline quinhydrone having a low surface to volume ratio. In addition such crystalline quinhydrone generally facilitates the inclusion of more quinhydrone particles, and thus more quinhydrone per se, into an electrode of a certain volume.

The use of such crystalline quinhydrone in pH potentiometric sensors or in other types of sensors is particular advantageous, and thus in a further aspect of the present invention there is provided a sensor including a dry working electrode formed at least in part of a sensing composition comprising crystalline quinhydrone, wherein said crystalline quinhydrone is characterized in that 90% or more of the particles have an aspect ratio equal to or less than 2.5.

In favorable embodiments of crystalline quinhydrone or sensors comprising such crystalline quinhydrone, the crystalline quinhydrone is characterized in that a majority of the particles have an aspect ratio equal to or less than 1.5. In addition or alternatively thereto, 90% or more of the particles may favorably have a maximum diameter equal to or less than 80 μm and/or a majority of the particles may favorably have a minimum diameter greater than 5 μm, in particular greater than 10 μm. In addition or alternatively thereto, a majority of the particles may favorably have an area greater than 100 μm² and/or a majority of the particles may favorably have an area equal to or less than 400 μm².

Sensors described herein are particularly useful in determining the state of a wound. Accordingly an addition aspect of the present invention is a method of determining the state of a wound, said method comprising measuring the pH of a wound, said measuring comprising contacting wound fluid and/or the wound site with a sensor as described herein and determining the pH of said wound fluid and/or wound site.

Other dependent claims define further favorable embodiments of the invention.

The above summary of the present invention is not intended to describe each disclosed embodiment or every implementation of the present invention. The description that follows more particularly exemplifies illustrative embodiments. In several places throughout the application, guidance is provided through lists of examples, which examples can be used individually and in various combinations. In each instance, the recited list serves only as a representative group and should not be interpreted as an exclusive list.

### BRIEF DESCRIPTION OF DRAWINGS, PHOTOGRAPHS AND GRAPHS

The invention will now be described with reference to the accompanying drawings, photographs and graphs in which:

FIG. 1 represents a schematic illustration of an exemplary sensor, illustrated in a top view as well as three cross-sectional views A, B and C.

FIG. 2 provides partial, schematic representation of four steps, A to D, in an exemplary fabrication of an exemplary sensor, such as a sensor illustrated in FIG. 1.

FIG. 3 provides illustrations of a further exemplary sensor; FIG. 3a providing a perspective view of the tip of the sensor; and FIG. 3b providing a top view of the sensor approximately in scale of its real dimensions.

FIG. 4 is a photograph of crystalline quinhydrone from Example 1.

FIG. 5 is a photograph of crystalline quinhydrone from Example 4.

FIGS. 6 and 7 are scatter plots of Aspect Ratio versus Maximum Diameter of crystalline quinhydrone from Example 1 and Example 4, respectively.

FIGS. 8 and 9 are plots of Minimum Diameter and Area, respectively, versus percentage of particles of crystalline quinhydrone from Example 1 (-♦-) and Example 4 (-*-).

FIGS. 10 and 11 are plots of responses of a quinhydrone working electrode of a sensor of the type of Example 2 versus standardized pH and versus time for a standardized pH of 6.96, respectively.

### DETAILED DESCRIPTION

It is to be understood that the present invention covers all combinations of particular, suitable, desirable, favorable, advantageous and preferred aspects of the invention described herein.

It will be understood that sensors described herein will be typically connected to an electronic device (e.g. a handheld electronic device). Such an electronic device for example may typically receive input from the sensor, calculate the measured parameter based on received input from sensor, and provide a read-out of the measured parameter to the user.

In the following an exemplary sensor in accordance to certain aspects of the present invention will be first described.

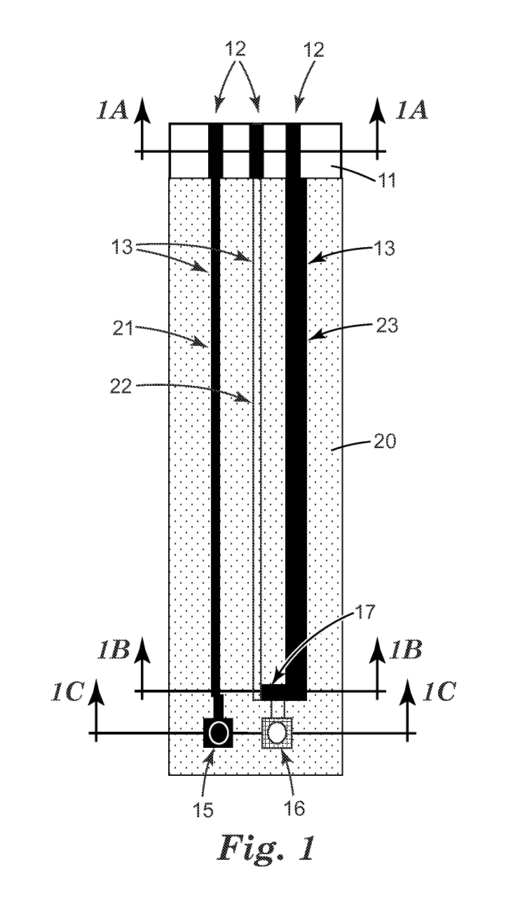

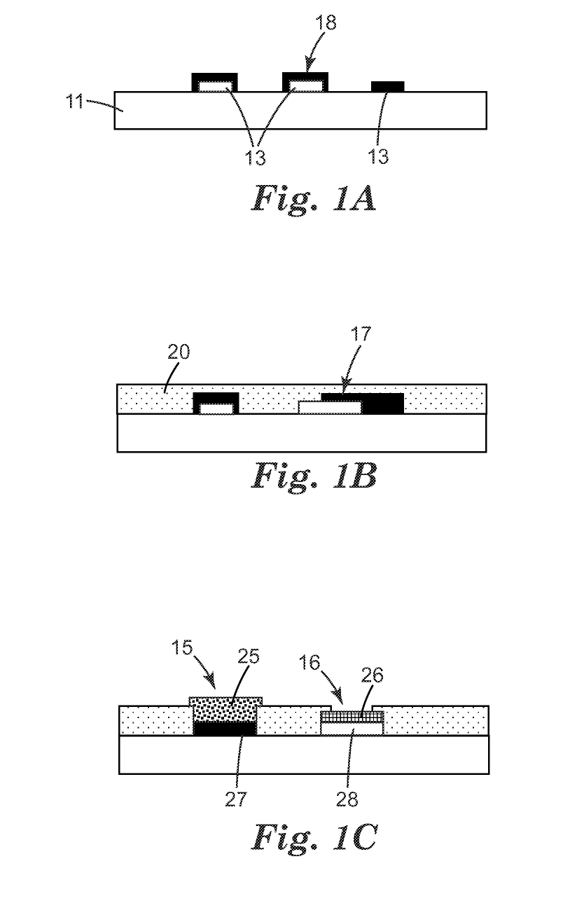

FIG. 1 provides a top view of an exemplary sensor (10) as well as cross sectional views at A-A, B-B and C-C. A sensor generally comprises a substrate (11), in particular an electrically non-conductive substrate, connection pads (12) and conductive tracks (13). The sensor (10) comprises a working electrode (15). It generally comprises a reference electrode (16). As illustrated in the exemplary sensor, the working electrode (15) may favorably include a conductive electrode base (27) and an over-layer (25) formed of a sensing composition as described herein. Similarly the reference electrode may include a conductive electrode base (28) and an over-layer (26) formed of a reference electrode composition. The exemplary sensor favorably includes at least one thermocouple, more favorably at least two thermocouples. Specifically the illustrated exemplary sensor (10) includes 2 thermocouples (17, 18). Favorably the sensor further comprises a dielectric layer (20).

Substrates, serving as electrically non-conductive support members, may typically be any cohesive, electrical non-conductor such as any electrical non-conductive body, film or sheet formed of polymeric material, ceramic, glass, paper, cardboard or any other material coated with an electrically non-conductive layer. Favorable thicknesses of non-conductive support materials in the form of a film or a sheet are from about 50 microns to about 2000 microns. Polymeric material, particularly non-conductive polymerics in the form of films or thin sheets are generally beneficial as they may be readily cut to strips of suitable size. In practice a strip-like substrate is generally a polymeric film or sheet. Any non-conductive polymeric film or sheet such as polyvinyl chloride, polyester, polycarbonate, vinyl acetate copolymer, nylon, poly (1,4-butleneterephthalate), cellulose propionate, ethylene/acrylic acid copolymer, polybutadiene, polyethylene, polypropylene, polyimide, acrylic film, polyurethane, polystyrene, and polyvinyl fluoride may be used. Polyester or polycarbonate films are generally used since they are readily available and easily handled.

To minimize any tendency of de-adhesion of applied conductive tracks, etc. due to substrate-distortion e.g. over aging or during application (e.g. during curing cycles), favorably substrates have low shrinkage/expansion properties, e.g. showing only a change in size in machine direction in the range of plus and minus 0.25% (inclusive) and/or in transverse direction in the range of plus and minus 0.025% (inclusive) after a treatment at 150° C. for 30 minutes.

In order to promote adhesion of conductive tracks applied to a substrate, it may be desired and/or deemed necessary to treat the surface of the substrate. Useful surface treatments include oxygen or nitrogen plasma treatment, adhesion-promoting coatings (e.g. conventional primers an example being an adhesion promoter marketed by Advanced Chemistry & Technology, Inc. Garden Grove, Calif., USA under the designation AC-137, USA), chemical vapor deposition or plasma enhanced chemical vapor deposition, mechanical surface treatments to increase of surface roughness, or other processes known by those skilled in the art.

Conductive tracks may be comprised of any electrically conductive material known in the art such as metallic silver, silver salts or mixtures thereof, conductive graphite or carbon, copper, platinum, cobalt, nickel, gold and electrically conductive polymers. Formulations of silver and carbon are favored as they are commercially available in the form of inks, are cost effective and provide excellent conductivity as thin films that may be deposited (e.g. coated) on a substrate by methods well known in the art such as screen printing, flexo printing, offset printing, gravure printing or digital printing (e.g. ink jet printing). An example of a suitable commercially available silver-containing ink include the ink formulation marketed under trade designation Electrodag 479 SS by Acheson Inc., Michigan and now by Henkel KGaA, Düsseldorf, Germany. Other examples are Electrodag PF-410 marketed by Acheson Inc., Michigan and now by Henkel KGaA, Düsseldorf, Germany or Du Pont 5000 marketed by Du Pont Ltd., Bristol, United Kingdom. An example of suitable commercially available carbon-containing ink include the ink formulation marketed under trade designation Electrodag 423 SS by Acheson Inc., Michigan and now by Henkel KGaA, Düsseldorf, Germany. Other examples are Electrodag PF-407A or Electrodag 965 SS marketed by Acheson Inc., Michigan and now by Henkel KGaA, Düsseldorf, Germany or Du Pont 5067 or Du Pont 7102 marketed by Du Pont Ltd., Bristol, United Kingdom. Typically, conductive tracks are screen printed on a substrate (such as a polyester or polycarbonate film) and cured, e.g. for about 30 minutes at about 80° C. or for about 5 minutes at about 120° C. Conductive tracks may differ in composition within a single sensor. Conductive tracks are generally formed first on an substrate, for example so that the respective conductive tracks may be at least partially covered by the sensor-electrodes (either the electrode per se or its conductive electrode base) in order to make good electrical contact. Typically the end portions of the conductive tracks located generally opposite of the electrodes form the connection pads. Favorable thicknesses of conductive tracks are from about 3 microns to about 15 microns.

Conductive electrode bases of electrodes may comprise electrically conductive carbon or graphite, copper, silver, gold, platinum, nickel, stainless steel, iron and other conductive materials and mixtures thereof. Conductive electrode bases may differ in composition within the same sensor. Formulations of electrically conductive carbon or graphite containing polymeric materials such as the electrically conductive inks available from Acheson Inc., now from Henkel KGaA, are typically favored as they are readily available and can be uniformly spread on a substrate to form a thin layer. Similar to conductive tracks, conductive electrode bases can be applied to the substrate by methods known in the art such as screen printing, flexo printing, offset printing, gravure printing or digital printing (e.g. ink jet printing). As recognized by the skilled reader the conductive electrode bases are applied as to provide an electrical contact with their respective conductive tracks. As discussed in more detail below, conductive electrode bases may be favorably created at the same time the conductive tracks are applied. Favorable thicknesses of conductive electrode bases are from about 3 microns to about 15 microns.

Dielectric layers (i.e. electrically insulating layers) are generally used for protection (e.g. protection against mechanical damage, protection against oxidation (of e.g. silver tracks), protection against moisture, fingerprints, etc.) and thereby in part enhancing the stability of the electrical properties of the sensor. For this reason a dielectric layer may typically cover the complete operating area of a sensor with the exception of the connection pads and the electrodes. Here it will be understood the boundaries of a dielectric layer may overlap in part onto connection pads and/or electrodes while leaving said connection pads and/or electrodes free of a covering so that their operative function remains essentially unhindered (e.g. allowing for proper connection of the sensor to an electronic device and for proper access of sample to the electrodes). The dielectric layer may be formed of any suitable dielectric material and applied in any suitable matter. It is beneficial to apply the dielectric layer using a similar or the same method used for applying conductive bases and conductive electrode bases, such as screen printing, flexo printing, offset printing, gravure printing or digital printing (e.g. ink jet printing). Examples of suitable commercially available dielectric formulations for applying an dielectric layer includes a formulation marketed under trade designation PD039A by Acheson Inc., Michigan, USA and now by Henkel KGaA, Düsseldorf, Germany or a formulation marketed under trade designation 5015 by Du Pont Ltd., Bristol, United Kingdom. Such formulations may be applied by printing, e.g. laying down a layer followed by curing, e.g. UV curing, to provide a biologically inert, acrylate complex. Favorable thicknesses of dielectric layers are from about 3 microns to about 30 microns.

Reference electrodes may be formed by providing a conductive electrode base on the substrate and then applying (e.g. coating, screen-printing) onto the surface of the conductive electrode base a reference electrode composition, for example comprising silver and silver chloride. Reference electrode formulations such as inks based on Ag/AgCl compositions are generally suitable and commercially available. Examples of such inks include Ag/AgCl-containing ink marketed under trade designation 5874 by DuPont Electronic Technologies or Electrodag 6037 SS marketed under trade designation PD039A by Acheson Inc., Michigan, USA and now by Henkel KGaA, Düsseldorf, Germany Any method known in the art for applying such inks may be used, such as screen printing, flexo printing, offset printing, gravure printing or digital printing (e.g. ink jet printing) may be used. Favorable thicknesses of reference electrode composition layers are from about 4 microns to about 15 microns. Favorable thicknesses of reference electrodes—including conductive electrode base and over-layer of reference electrode composition—are from about 7 microns to about 30 microns.

Reference electrodes may be advantageously over-coated with a composition comprising a salt to facilitate the provision of a stable salt concentration in the vicinity of the reference electrode. It has been found particularly useful to over-coat reference electrodes with a cured composition comprising potassium chloride, polyvinylalcohol and melamine resin. For example an aqueous formulation comprising potassium chloride, polyvinylalcohol (such as those marketed under the trade designation Mowiol by The Dow Chemical Company, Wilmington, Del., USA) and a melamine-resin (e.g. a reactive, cross-linkable, modified melamine-resin, such as the melamine resins marketed under trade designation Cymel by Cytec Surface Specialties SA/NV, Brussels, Belgium) may be coated onto a reference electrode and after coating the formulation may be cured for at 120° C. for 10 min.

Working electrodes may be formed by either providing a sensing composition—in accordance to certain aspects of the present invention and described in detail below—including in addition a conductive component (e.g. active carbon) on the substrate or, more desirably, by providing a sensing composition without such a conductive component onto a conductive electrode base already provided on the substrate. As previously mentioned electrodes formed with sensing compositions in accordance to certain aspects and embodiments described herein are advantageous in that the use of a conductive component is typically not necessary (nor desired) to allow for good and desirable response. Furthermore the latter aforesaid process is favored as this process is more efficient in manufacturing and allows for the production of more uniform products. Any application method known in the art such as drop coating, screen-printing, flexo printing, spread coating, offset printing, gravure printing or digital printing (e.g. ink jet printing) may be used. Sensing composition described herein allow the provision of thin layers. Favorable thicknesses of layers made of a sensing composition are from about 10 microns to about 75 microns. Favorable thicknesses of working electrodes—including conductive electrode base and over-layer of sensing composition—are from about 13 microns to about 90 microns.

In one aspect of the present invention a sensing composition comprises quinhydrone and at least one water soluble derivative of a polysaccharide. As indicated above such sensing compositions are particularly advantageous for the provision of disposable pH sensors, and accordingly such sensors include a dry working electrode formed at least in part of such a sensing composition. As mentioned in the previous paragraph, favorable working electrodes are formed of at least two layers: a conductive electrode base and a sensing composition provided on (e.g. dried onto) the conductive electrode base.

As used herein “poly” in polysaccharides refers to polymers having a number average molecular weight equal to or greater than 1800. Favorably the number average molecular weight is equal to or less than about 220,000.

As used herein, the term “water soluble” refers to polymers that form a solution in water containing 1 (one) percent by weight of a polymer at 20° C. and a pH of 5-9 that is free of insoluble polymer particles. A useful determination that a solution is free of insoluble polymer particles can be made by the measurement of its turbidity, which can be defined as the reduction of transparency of a liquid caused by the presence of un-dissolved matter. The turbidity of an aqueous solution containing 1 (one) percent by weight of a polymer, at a pH of 5-9 and a temperature of 20° C., can be measured using a turbidimeter or nephelometer. A polymer is defined as “water soluble” if the turbidity of such a solution is equal to or less than 50 FNU (formazine nephelometric units) (in particular equal to or less than 35 FNU, more particularly equal to or less than 20 FNU) when measured according to ISO 7027.

As mentioned above, the at least one water soluble derivative of a polysaccharide in the sensing composition is preferably not cross-linked.

The sensing composition may comprise a single water soluble derivative of a polysaccharide or a plurality of water soluble derivatives of a polysaccharide. The at least one water soluble derivative of a polysaccharide is preferably at least one water soluble ester or ether derivative of a polysaccharide, more preferably at least one water soluble ester or ether cellulose, even more preferably at least one water soluble ether cellulose, and most preferably at least one water soluble ether cellulose selected from the group consisting of sodium carboxymethylcellulose (CMC), hydroxyethylcellulose (HEC), carboxymethylhydroxyethylcellulose (CMHEC), hydroxypropylcellulose (HPC), methylcellulose (MC), hydroxypropylmethylcellulose (HPMC), hydroxybutylmethylcellulose (HBMC), hydroxyethylmethylcellulose (HEMC), ethylcellulose (EC), ethylhydroxyethylcellulose (EHEC, HEEC), dihydroxypropylcellulose, hydroxyethylhydroxypropylcellulose, and mixtures thereof.

In another aspect of the present invention a sensing composition comprises crystalline quinhydrone in accordance with another aspect of the present invention (described in more detail below). Such crystalline quinhydrone is characterized in that 90% or more of the particles have an aspect ratio equal to or less than 2.5. As mentioned above the application of such sensing compositions is beneficial for all types of sensors (in particular pH sensors), and accordingly such sensors include a dry working electrode formed at least in part of such a sensing composition.

If desired, sensing compositions of electrodes described herein may comprise other components, such as e.g. coloring agents (e.g. pigments, dyes), fillers or surfactants. It will be recognized by the skilled reader that for working electrodes for pH sensors, the inclusion of any additional component desirably does not interfere with the redox reaction of the benzoquinone/hydroquinone couple, nor otherwise react with the quinhydrone complex.

Sensing compositions of electrodes described herein are favorably essentially free (i.e. no more than 5 wt. % of the total dried sensing composition) or free of a hydrophobic polymer, among other things in order to facilitate function as a depth electrode and/or maintenance of desired function as a depth electrode.

Sensors may include a sensing composition that has been dried onto a conductive electrode base provided on a sensor substrate. Or alternatively sensors may include a sensing composition dried onto a sensor substrate and in electrical contact with a conductive path provided on said substrate. The former is generally favored.

Favorable methods of preparing a sensor, e.g. a disposable sensor, where the sensor comprises a substrate provided with at least one conductive path, comprises a step of forming a working electrode, wherein either
said step of said forming comprises depositing and drying an aqueous sensing composition-comprising formulation (e.g. a quinhydrone ink described herein) onto a conductive electrode base that is provided on the substrate and is in electrical contact with said conductive path;
or
said step of said forming comprises depositing and drying an aqueous sensing composition-comprising formulation (e.g. quinhydrone ink as described herein) onto the substrate such that the formed working electrode is in electrical contact with said conductive path provided on the substrate.

As can be appreciated, methods may favorably include additional steps such as providing a substrate, providing at least one conductive path onto the substrate, while methods in accordance to the former method may favorably further comprises a step of providing a conductive electrode base onto the substrate, such that the base is in electrical contact the at least one conductive path.

Referring to FIG. 2, a method of fabrication of a three (e.g. parallel) line sensor, such as an exemplary sensor of the type illustrated in FIG. 1, may favorably comprise the following steps:

a) provision of a substrate (not visible in FIG. 2; e.g. a polyester or polycarbonate film);

b) application (e.g. by printing) of a first formulation comprising a first conductive material (e.g. comprising silver) so as to form conductive paths of the first and second lines, connection pads at the first ends of the first and second lines and in the region near the second end of the second line a conductive electrode base (see FIG. 2A reference number 30);

c) application (e.g. by printing) of a second formulation comprising a second conductive material (e.g. comprising carbon) so as to form a conductive path of the third line, a connection pad at the first end of the third line, an overlap of the second end of third line in the region near the second end of the second line but spaced apart from said conductive electrode base thereby forming a thermocouple and so as to overcoat the first line and form in contact to the second end of the first line a second conductive electrode base (in particular whereby the first and second conductive electrode bases are side-by-side but spaced apart) as well as to overcoat the first end of the second line thereby forming a second thermocouple (see FIG. 2B);

d) application (e.g. by printing) of a third formulation comprising a reference electrode composition (e.g. comprising Ag/AgCl) so as to form an over-layer of the reference electrode composition onto the first conductive electrode base thereby forming the reference electrode (see FIG. 2C);

e) application (e.g. by printing) of a dielectric material so as to form dielectric layer over essentially the complete operating area of the sensor leaving the connection pads, the reference electrode and the second conductive electrode base essentially completely uncovered (see FIG. 2D); and

f) application (e.g. by drop coating or printing) of a fourth formulation (e.g. a quinhydrone ink as described herein) comprising a sensing composition (e.g. comprising quinhydrone and at least one water soluble derivative of a polysaccharide as described herein and/or comprising a crystalline quinhydrone as described herein) so as to form an over-layer of the sensing composition onto the second conductive base thereby forming the working electrode (not represented in FIG. 2).

The aforesaid method is advantageous in that it efficient allowing for cost-effective, large scale manufacture of sensors using a low number of process steps. For example in merely two steps all the conductive paths, conductive pads, thermocouples and conductive electrodes bases are provided (in particular printed) for such an exemplary three-line sensor.

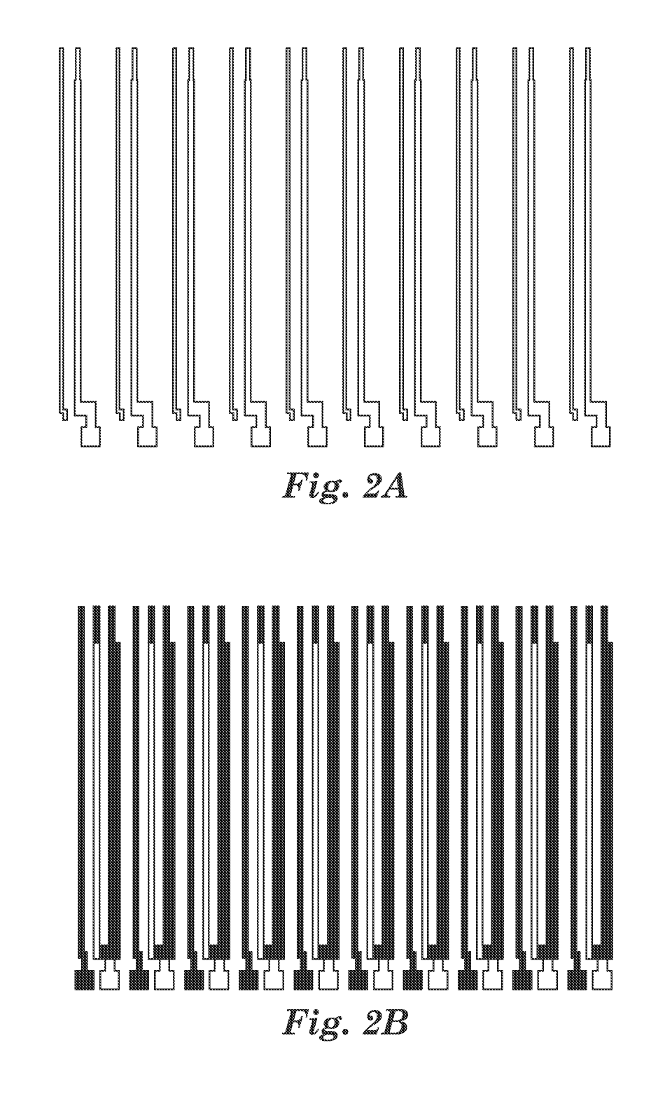

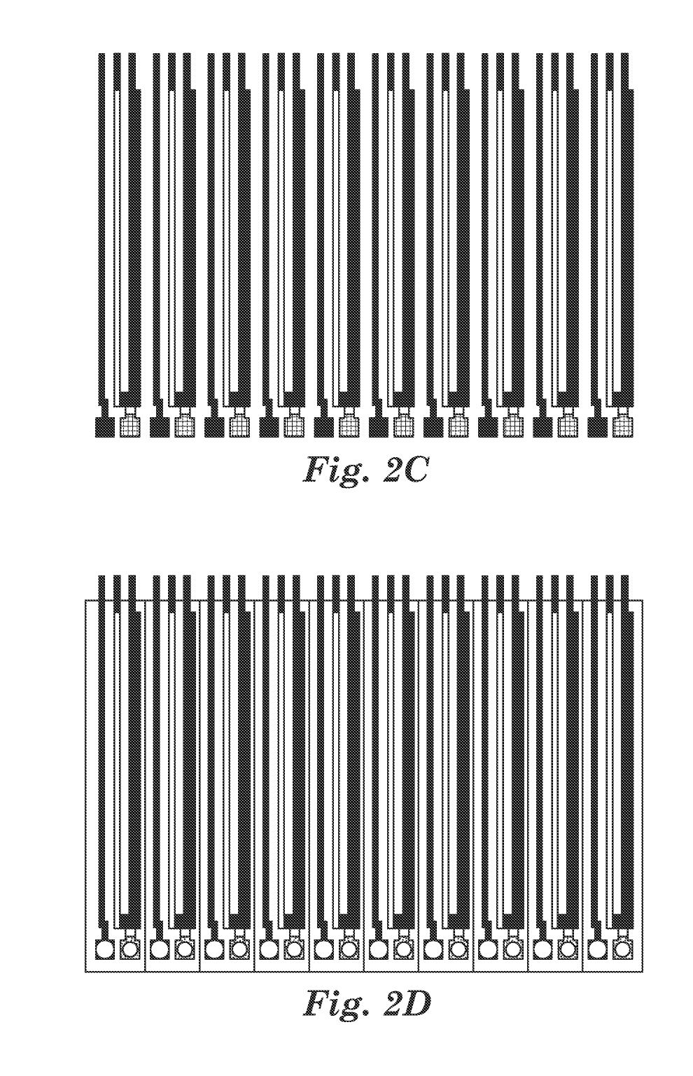

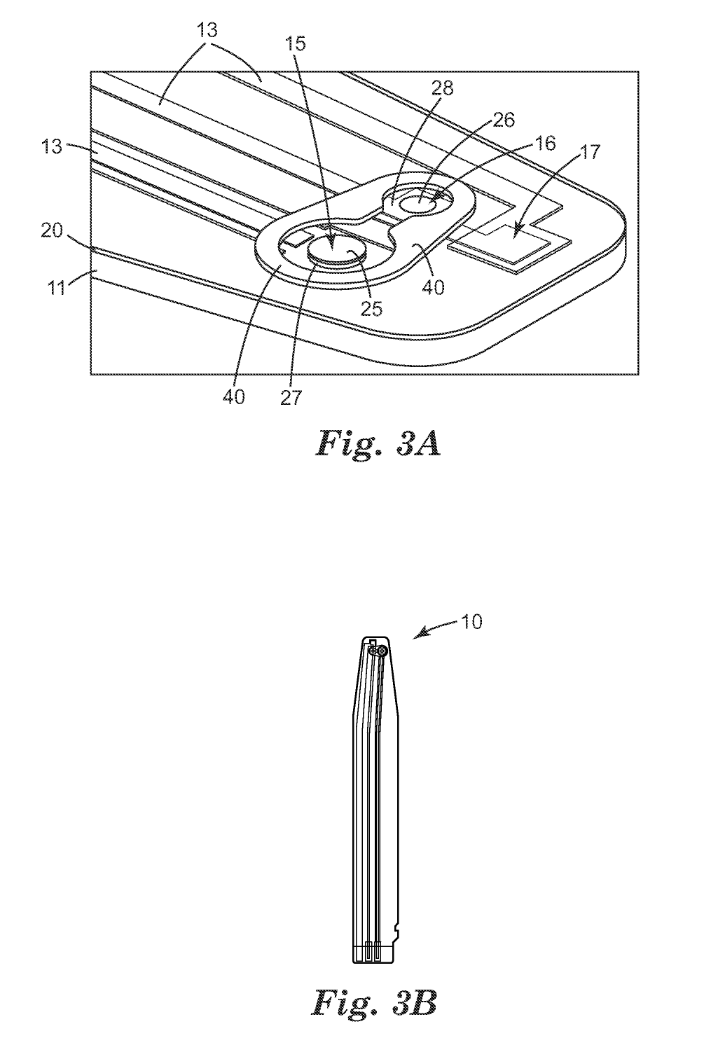

Another exemplary sensor is illustrated in FIG. 3, where FIG. 3a provides a perspective view of the tip of the sensor. In the following the same reference numbers are used for elements that are similar to that shown in FIG. 1. Similar to the first exemplary sensor, this sensor generally comprises a substrate (11), conductive paths (13), a reference electrode (16) and favorably with at least one thermocouple (17) positioned near the reference electrode. The reference electrode (16) is desirably formed of a conductive electrode base (28) and a reference electrode composition over-layer (26). The working electrode (15) is favorably formed of a conductive electrode base (27) and sensing composition over-layer (25). Like the first exemplary sensor, this sensor desirably includes a dielectric layer (20). The working and reference electrodes (15, 16) are advantageously arranged side-by-side, but spaced apart, and the two electrodes are surrounded by a ring wall—that may be closed as illustrated or partly open and is best described as an atoll (40). The atoll (40) protects the two electrodes prior to and during use, and also during use the atoll facilitates collection of sample into its lagoon and thus to the electrodes located in the lagoon. Like a dielectric layer, the atoll is favorably made of a dielectric material, such as those listed above. Favorably such an atoll has a wall height at its maximum point of about 30 μm or more, more favorably about 40 μm or more, most favorably about 50 μm. Within the aforesaid ranges, favorably such an atoll has a wall height at its maximum of about 150 μm or less, more favorably of about 100 μm or less, and most favorably about 75 μm or less. The exemplary sensor may be favorably produced as described above, with the inclusion of an additional step of making the atoll. Here for example after step e) and prior to step f), the method may include application (e.g. by printing) of a dielectric material so as to form an atoll surrounding the reference electrode and the second conductive electrode base. FIG. 3b provides a top view of the second exemplary sensor approximately in scale of its real dimensions (i.e. having an overall length of about 8 cm and a width of 1 cm at widest point).

Sensors described herein may be suitably and advantageously used for measurement (in particular pH measurements) of aqueous-based samples, for example in laboratories (possibly replacing the glass electrode); in chemical or biotechnical industry; for measurement of water quality for example of rivers, ponds, pools, or aquariums; in food industry e.g. for measurement of diary products, honey products, meat-products and beverages (e.g. beer).

Sensors described herein are particularly advantageous for use in in vivo measurements. This holds particularly true because of a desirable resistance to sterilization, desirable short response times and overall small size of the working electrodes and thus the sensing portion of the sensors. Desirably sensors are configured and arranged to allow for in vivo potentiometric measurement (in particular in vivo potentiometric pH measurements) for example in wounds (e.g. measurement of wound fluids, such as exudate and/or transudate), on skin (e.g. measurement of lymphorrhoea, sweat, glandular secretions), on mucous membranes (e.g. measurement of mucus), in dental pockets or on gum tissue (e.g. measurement of gingival exudate, salvia), on/in dental surfaces/caries. Other examples of in vivo measurements including in vivo measurements in various body cavities including e.g. oral, oesphageal, gastral, duodenal, intestinal, rectal, ureteral, vesical, abdominal, vaginal, and ocular measurements.

Sensors described herein may also be advantageously used for in vitro measurements (such as in vitro pH measurements) of collected samples, such as, among others, blood, serum, spinal fluid, urine, semen, and faeces, as well as wound fluids, exudates, transudates, lymphorrhoea, sweat, glandular secretions, mucus, saliva and tears.

Sensors, in particular pH sensors, described herein may be used in conjunction with protease (e.g. matrix metalloproteinase, such as MMP-9) detection devices or systems or alternatively sensors or working electrodes described herein may be provided as an integral component of a protease detection device or system.

Sensors, in particular pH sensors, described herein may be used in conjunction with NO-related-compound(s) detection devices or systems or alternatively sensors or working electrodes described herein may be provided as an integral component of a NO-related-compound(s) detection device or system. NO-related-compounds include nitric oxide and derivatives thereof, such as nitrate compounds and nitrite compounds. Exemplary devices and methods for detecting NO-related compounds are described in U.S. Patent Application No. 61/231,236, filed on Aug. 4, 2009 and entitled “Sampling Devices and Methods of Use”, which is incorporated herein by reference in its entirety and U.S. Patent Application No. 61/231,257, filed on Aug. 4, 2009 and entitled “Method of Detecting Oxides of Nitrogen”, which is incorporated herein by reference in its entirety

As mentioned above sensors described herein are particularly useful in determining the state of a wound. A method of determining the state of a wound comprises measuring the pH of a wound, said measuring step comprising contacting wound fluid and/or a wound site with a sensor as described herein and determining the pH of said wound fluid and/or wound site. Favorably the duration of contacting is one minute or less, or more favorably 30 seconds of less. Such methods may favorably include detection of proteases (in particular matrix metalloproteinases, more particularly MMP-9) and/or NO-related-compounds. Such methods may also favorably include detection of one or more other analytes that are generally indicative of the state of the wound, such as total protein, proteins, protein fragments, cytokines, polynucleotides, growth factors, microorganisms or fragments thereof, microorganism by-products. Such detection may favorably include detection of the presence and/or the specific identity and/or the amount of said analyte. As desired and/or needed, such detection may be carried our prior to measuring the pH or simultaneously with measuring the pH or subsequent to measuring the pH.

Sensors may be provided in various forms, e.g. any flat shape or any shape which can be derived from a flat material by folding, corrugation, bending or stacking. Sensors may be in the form of single-layer substrate strips, patches, dimpled arrays (e.g. arrays (for example in the form of test strip or blocks) with reservoirs or cavities) or other types of arrays allowing for multiparameter measurement. Alternatively sensors may be in the form of a “stacked” strip, e.g. formed of 2 or more insulating substrate-layers stacked, where electrode layer(s) are provided between the substrate layers, and where the access to the electrode(s) may be provided externally, e.g. at the outer end of the stack, or internally, e.g. via access ports and/or capillary channels provided between the substrate layers. Alternatively sensors may be provided in the form of a tampon or a stick (e.g. an insertion-stick) with electrodes provided either at the top-end and/or one of the sides. Alternatively sensors can be configured and arranged to operate in a microfluidic array or as a flow-through type of sensor in which e.g. sample is continuously or discontinuously forced to flow across the sensor surfaces by pumps or any other means.

A preferred form is a single layer substrate strip. Such sensors strips are favorably stiff enough to allow for connect into electronic devices, but flexible enough to allow proper contact to the sample, in particular in in vivo situations. Sensor strips are favorably from about 0.5 cm to about 30 cm in length. Sensor strips are favorably from about 0.25 cm to about 4 cm wide. Sensor strips are favorably from about 50 to about 2000 microns thick.

Advantageous e.g. for in construction of sensors in vivo measurements and/or sensors having an overall small size, individual layers making up electrodes (in particular working electrodes) desirably have a thickness of about 75 microns at most, more desirably equal to or less than about 60 microns, even more desirably equal to or less than about 45 microns, and most desirably equal to or less than about 30 microns. Desirably the electrodes (in particular working electrode) have an access-area of about 16 mm² at most, more desirably equal to or less than about 10 mm², even more desirably equal to or less than about 6 mm², most desirably equal to or less than about 4 mm² Access-area is to be understood the area to which the sample has access to the dry electrode.

Certain aspects of the present invention include a method of preparing crystalline quinhydrone for the use in or as a quinhydrone ink in the manufacturing of a sensor, said method comprising a step of combining aqueous solutions of benzoquinone and hydroquinone in the presence of at least one additive, wherein the concentrations of the aqueous solutions of benzoquinone and hydroquinone are such that the concentration of quinhydrone formed upon said combining exceeds the solubility of quinhydrone at the temperature at which said combining is performed and wherein the at least one additive is at least one water soluble derivative of a polysaccharide.

The initial concentration of the at least one additive may be favorably provided such that upon completion of the step of combining, the weight by weight concentration of said at least one additive is at least 0.05%, in particular at least 0.1%, more particularly at least 0.2%, and most particularly at least 0.4%. The initial concentration of the at least one additive may be desirably provided such that upon completion of the step of combining the weight by weight concentration of said at least one additive is at most 10%, in particular at most 5%, more particularly at most 2%, and most particularly at most 1%.

The at least one additive is at least one water soluble derivative of a polysaccharide. Moreover a single water soluble derivative of a polysaccharide or a plurality of water soluble derivatives of a polysaccharide may be used. The at least one water soluble derivative of a polysaccharide is preferably at least one water soluble ester or ether derivative of a polysaccharide, more preferably at least one water soluble ester or ether cellulose, even more preferably at least one water soluble ether cellulose, and most preferably at least one water soluble ether cellulose selected from the group consisting of sodium carboxymethylcellulose (CMC), hydroxyethylcellulose (HEC), carboxymethylhydroxyethylcellulose (CMHEC), hydroxypropylcellulose (HPC), methylcellulose (MC), hydroxypropylmethylcellulose (HPMC), hydroxybutylmethylcellulose (HBMC), hydroxyethylmethylcellulose (HEMC), ethylcellulose (EC), ethylhydroxyethylcellulose (EHEC, HEEC), dihydroxypropylcellulose, hydroxyethylhydroxypropylcellulose, and mixtures thereof.

Favorably and advantageously the step of combining is performed at a temperature equal to or less than 45° C., more favorably at a temperature equal to or less than 35° C., and most favorably equal to or less than 27° C. Favorably the step of combining is performed at a temperature equal to or greater than 5° C., more favorably at a temperature equal to or greater than 10° C., and most favorably at temperature equal to or greater than 15° C.

To facilitate high yields of crystalline quinhydrone, desirably the aqueous solutions of benzonquinone and hydroquinone are (independently) saturated or nearly saturated. As will be recognized by those skilled in art, the term “saturated” in a saturated solution, refers to a point of maximum concentration, in which no more solute (such as benzoquinone or hydroquinone) may be dissolved in a solvent (such as water) at the relevant temperature (e.g. the temperature at which the step of combining is performed). The term “nearly saturated solution” as used herein, it to be considered an aqueous solution that is at least 70% of maximum concentration of benzoquinone and hydroquinone, respectively, more particular about at least 80% of the maximum concentration, most particularly at least 90% of said maximum concentration.

Desirably, aqueous solutions of benzoquinone and hydroquinone are equimolar or nearly equimolar. This means that the molar concentrations of the aqueous solutions are provided such that the number of molecules of hydroquinone and benzoquinone taking part in the reaction forming quinhydrone is identical or nearly identical. As used herein the term “nearly equimolar” means that the hydroquinone/benzoquinone ratio is from 0.8 to 1.2 (more particularly from 0.9 to 1.1, and most particularly from 0.99 and 1.01).

Prior to the step of combining, the method may comprise either forming an aqueous solution of benzoquinone containing said at least one additive and forming an aqueous solution of hydroquinone, or alternatively forming an aqueous solution of hydroquinone containing said at least one additive and forming an aqueous solution of benzoquinone. It has been found advantageous in terms of efficiency and effectiveness to form an aqueous solution of benzoquinone containing said at least one additive and an aqueous solution of hydroquinone, and thereafter in the step of combining, to add the aqueous solution of hydroquinone to the aqueous solution of benzoquinone containing said at least one additive.

Methods of preparing crystalline quinhydrone as described above favorably provides a dispersion of desirable crystalline quinhydrone (discussed in more detail below) in an aqueous solution comprising the at least one additive, Such dispersions can be used as obtained as quinhydrone inks in the manufacture of sensors and/or working electrodes.

Alternatively such dispersions may be for example further concentrated before use as quinhydrone inks. Accordingly another aspect of the present invention include preparing a quinhydrone ink for use in the manufacturing of a sensor, said method comprising the steps of: providing crystalline quinhydrone as described; allowing the crystalline quinhydrone to sediment; removing part or all of the supernatant; and adding a liquid to the sediment and dispersing the sediment in said liquid.

Favorably the liquid is water or a water/solvent mixture.

Favorably the liquid comprises at least one modifier. More favorably the liquid is an aqueous solution comprising at least one modifier, wherein the at least one modifier is at least one a water soluble derivative of a polysaccharide. A single or a plurality of water soluble derivatives of a polysaccharide may be used as modifier. Similar to the method of preparing crystalline quinhydrone as described above, preferably the at least one water soluble derivative of a polysaccharide is at least one water soluble ester or ether derivative of a polysaccharide, more preferably at least one water soluble ester or ether cellulose, even more preferably at least one water soluble ether cellulose, most particularly at least one water soluble ether cellulose selected from the group consisting of sodium carboxymethylcellulose (CMC), hydroxyethylcellulose (HEC), carboxymethylhydroxyethylcellulose (CMHEC), hydroxypropylcellulose (HPC), methylcellulose (MC), hydroxypropylmethylcellulose (HPMC), hydroxybutylmethylcellulose (HBMC), hydroxyethylmethylcellulose (HEMC), ethylcellulose (EC), ethylhydroxyethylcellulose (EHEC, HEEC), dihydroxypropylcellulose, hydroxyethylhydroxypropylcellulose, and mixtures thereof. The at least one modifier may be the same as the at least one additive, and thus the resulting product includes in total the same at least one additive/modifier (since some additive remains in the wet crystalline quinhydrone sediment even after removing all of the supernatant). The at least one modifier may be different (or in part different) as the at least one additive, so that the resulting product includes in total the at least one modifier and the at least one additive.

As mentioned above, if desired, a sensing composition of an electrode may comprise other components, such as coloring agents, fillers or surfactants, and/or a sensing composition may include a conductive component (such as conductive carbon). In methods of preparing quinhydrone inks for use in manufacture of sensors, it is preferred that any inclusion of any such component(s) is performed at least after the step of providing crystalline quinhydrone. Such component(s) may be appropriately added (e.g. blended into) to the quinhydrone dispersion prior to the allowing-to-sediment step; or alternatively such component(s) may be included into the liquid comprising at least one modifier and thus added when the liquid is added to the sediment; or alternatively component(s) may be added while or after dispersing the sediment in said liquid.

Products for use as quinhydrone inks prepared according methods described herein are favorably essentially free (i.e. no more than 5 wt % of the total dried sensing composition) or free of a hydrophobic polymer.

Products for use as quinhydrone inks prepared according to methods described herein desirably have a viscosity at 23° C. (e.g. as determined using a Brookfield viscosimeter (Spindle No. 3, speed 10 rpm)) equal to and greater than 5 mPa·s, more desirably equal to and greater than 750 mPa·s, even more desirably equal to and greater than 1250 mPa·s, and most desirably equal to and greater than 2000 mPa·s. Products for use as quinhydrone inks prepared according to methods described herein desirably have a viscosity at 23° C. (e.g. as determined using a Brookfield viscosimeter (Spindle No. 3, speed 10 rpm)) equal to and less than 2,000,000 mPa·s, more desirably equal to and less than 1,000,000 mPa·s, even more desirably equal to and less than 500,000 mPa·s yet even more desirably equal to and less than 100,000 mPa·s, and most desirably equal to and less than 10,000 mPa·s.

As indicated above products for use as quinhydrone inks as described herein may be advantageously used in the manufacture of a sensor (e.g. a disposable sensor) the sensor comprising a substrate provided with at least one conductive path, where the method includes a step forming a working electrode said step comprising depositing quinhydrone ink onto a conductive electrode base that is provided on the substrate and is in electrical contact with said conductive path and drying the ink. Alternatively if an quinhydrone ink comprises a conductive component (such as carbon), the method may comprise a step forming a working electrode, said step comprising depositing quinhydrone ink onto the substrate and drying the ink, such that the formed working electrode is in electrical contact with said conductive path provided on the substrate.

The use of the at least one water soluble derivative of a polysaccharide additive (as described above) in methods of preparing of crystalline quinhydrone surprisingly provides crystalline quinhydrone having desirable particle properties, in particular squared or globular-like crystalline particles. Such crystalline quinhydrone is characterized in that 90% or more of the particles have an aspect ratio equal to or less than 2.5. This result is particularly surprising since it seems to be unrelated to viscosity but rather to some unexpected and at least presently inexplicable interaction with the at least one water soluble derivative of a polysaccharide additive. As mentioned previously such crystalline quinhydrone materials are advantageous for use in electrodes due to desirable stability as a result of high number of particles of the crystalline quinhydrone having a low surface to volume ratio, as well as allowing for high packing of quinhydrone particles, and thus quinhydrone, per a certain volume. In favorable embodiments of such crystalline quinhydrone a majority of the particles have an aspect ratio equal to or less than 1.5. Such crystalline quinhydrone materials may also have advantageous size properties, e.g. a small size further facilitating high packing and/or e.g. a size “not too small” further promoting desirable stability. In particular in such desirable embodiments of crystalline quinhydrone materials, 90% or more of the particles have a maximum diameter equal to or less than 80 μm, more particularly equal to or less than 70 μm, even more particularly equal to or less than 60 μm, yet even more particularly equal to or less than 50 μm, most particularly equal to or less than 40 μm. In addition or alternatively in desired crystalline quinhydrone materials, a majority of the particles have a minimum diameter greater than 5 μm, more desirably greater than 10 μm. Favorably a majority of the particles have an area greater than 100 μm². Favorably a majority of the particles have an area equal to or less than 400 μm².

The invention is further exemplified by the following detail examples, which are not intended to limit the scope of the invention

### EXPERIMENTAL

### Test Method

### Determination of Aspect Ratio, Diameter(s) and Area Via Optical Microscopy

I. Sample Preparation (reference is made to 4.1 of ISO 13322-1:2004 and standard microscopy practices)

For analysis one drop (ca. 0.2-0.3 g) of a dispersion of the particle-sample to-be-measured is put on an ordinary, clean microscope slide, a cover glass is applied and the cover slide is gently pressed onto the slide by a parallel plate sample press.

In the event of that the sample to-be-measured is not already present in a dispersion, any method can be used to provide a dispersion so long that the particles of sample are well-dispersed by the method and that there is no segregation of particles by size (see 4.1.2 of ISO 13322-1).

The prepared slide is then examined to determine whether

a) a sufficiently thin film of the particle-sample between the microscope slide and the cover slide has been prepared (e.g. in order to be able to get a sharp image of the particles); and

b) that the particles are not agglomerated and the number of particles touching each other is a minimal allowing for measurement on isolated particles (see 4.1.3 ISO 13322-1); and

c) over whole area of prepared slide there is no noticeable segregation of particles (by size) (see 4.1.4 ISO 13322-1).

In the event the prepared slide is deemed unsuitable a new sample-slide should be remade.

Imaging of the particles is carried out within 5 minutes after preparation of the slide.

### II. Analysis

A Reichert-Jung Polyvar MET Microscope (C. Reichert Optische Werke AG, Hernalser Hauptstr. 219, A-1171 Wien, Austria) is employed in conjunction with a digital camera ColorView II (available from Olympus Soft Imaging Solutions GmbH, Johann-Krane-Weg 39, 48149 Münster, Germany) with a maximum resolution of 2080×1544 pixels and a color depth of 24 bit. A 10× objective is used to obtain high resolution digital photographs and with the given resolution of 2080×1544 pixels resulting in a imaged area of 893.8 μm×663.5 μm (pixel length and width=0.42971 μm; pixel area=0.185 μm²). A series of non-overlapping images (at least a minimum of about 800 particles are photographed) is taken over a short period (circa three minutes) using transmission mode. Digital photographs were uploaded in a computer for analyses.

“Analysis” software (Version No. 3.2 Build 821) from Olympus Soft Imaging System GmbH (Johann-Krane-Weg 39, 48149 Münster, Germany) is used for automatic measurement and analyses of the photographed particles. Images are examined with using a selected threshold setting which binarizes the image (i.e. clearly separates the particle image from the background) and then the images of the sample particles are automatically measured and analyzed for minimum diameter, maximum diameter, aspect ratio and area. Automatic analysis of the images is done after setting a threshold with so that the program is able to binarize the image, i.e. background and particle. For diameters, the basic procedure used by the software is to measure diameters of a photographed particle by rotating two parallel lines around the complete particle (0° to 179° at a step width 1°) adjusting the space between the parallel lines so that each line just touches the outer edge of the particle, and measuring the length of space with the two lines. Minimum Diameter is defined as the minimum value of all the measured diameters of a particle; and Maximum Diameter is defined as the maximum value of all the measured diameters of a particle. For determining Aspect Ratio, the basic procedure used by the software is to rotating a rectangle around the complete particle (0° to 179° at a step width of 1°), adjusting the lengths of the sides so that each side just touches the outer edge the particle, then measuring the length of the two sides, a and b, and determining the maximum ratio of length a to length b of all measured a/b-pairs, said ratio being defined as the Aspect Ratio. For Area, the number of pixels within the boundaries of a particle is counted, and area is defined as the total number of pixel counted for a particle times the area of a pixel.

The number of particles to be measured and analyzed is at least 800.

### EXAMPLES

### Example 1

### Preparation of Quinhydrone Ink

The following solutions were prepared at 23° C.

### Solution 1:

5 g of hydroxypropylmethylcellulose (marketed under trade designation METHOCEL E 15 by the The Dow Chemical Company, Wilmington, Del., USA (methoxy content 28-30%, hydroxypropyl content 7-12%; viscosity of 2% solution in water 12-18 mPa·s) was added to 95 g of distilled water under stirring at 2000 rpm. After complete addition (within about 1 min) of the hydroxypropylmethylcellulose, the solution was then stirred for 5 hours at 400 rpm.

### (Benzoquinone) Solution 2:

3.00 g Benzoquinone (Fluka, No 12309) was added to 317.00 g of distilled water under stirring at 500 rpm and then mixture was stirred at 500 rpm until the substance dissolved to form a clear yellow solution.

A 48.00 g aliquot of the Solution 1 was then added and then the solution was stirred for 2 min at 400 rpm.

### (Hydroquinone) Solution 3:

3.056 g of Hydroquinone (Riedel.de-Haen, min. 99.5%, No. 15616) was added to 48.00 g of distilled water and stirred at 500 rpm until the substance dissolved to form a clear liquid.

### Solution 4:

A mixture of 30 g of hydroxypropylmethylcellulose (marketed under trade designation METHOCEL E 15) and 3.0 g of hydroxypropylmethylcellulose (marketed under trade designation METHOCEL 311) was added (in about 60 sec) to 578 g of distilled water under stirring at 2000 rpm and the solution was then stirred for 5 hours at 400 rpm.

Crystallization of quinhydrone was performed at 20° C. as follows: Hydroquinone-Solution 3 was added drop wise (fast) via a dropping funnel into Benzoquinone-Solution 2 under stirring at 500 rpm. After Solution 3 was completely added, the solution was stirred 5 minutes at 500 rpm until particles are formed. Thereafter the stirring was stopped, and the quinhydrone particles were allowed to precipitate and sediment (sedimentation was complete in about 4 hours). Solubility of Quinhydrone in water is 3.491 g/L at 20° C., and thus after Solutions 2 and 3 have been combined 6.056 g of Quinhydrone results, and after crystallization and sedimentation there is 1.433 g in solution and 4.623 g in the precipitate. Also after Solutions 2 and 3 have been combined, the mixture contained 2.4 g of hydroxypropylmethylcellulose, i.e. 0.57 wt % ([2.4 g/(2.4+6.056+410.6)g]×100%), in solution.

After sedimentation, 383 g of supernatant (and thus 1.337 g of Quinhydrone in solution and 2.239 of hydroxypropylmethylcellulose in solution) was removed using a 100 ml-pipette. Thereafter 264 g of Solution 4 was added under mixing.

The resulting product was used as a quinhydrone ink. It has a composition corresponding to 4.719 g quinhydrone, 13.123 g hydroxypropylmethylcellulose (marketed under trade designation METHOCEL E 15), 1.296 g hydroxypropylmethylcellulose (marketed under trade designation METHOCEL 311) and 280.941 g of water. Accordingly a 1 μl drop of said ink (approx. 1 mg) contains 16 μg quinhydrone; 500 nl of the quinhydrone ink contain 8 μg quinhydrone. The ink has a viscosity of 3540 mPa·s as determined using a Brookfield viscosimeter (Spindle No. 3, speed 10 rpm, temperature 23° C.).

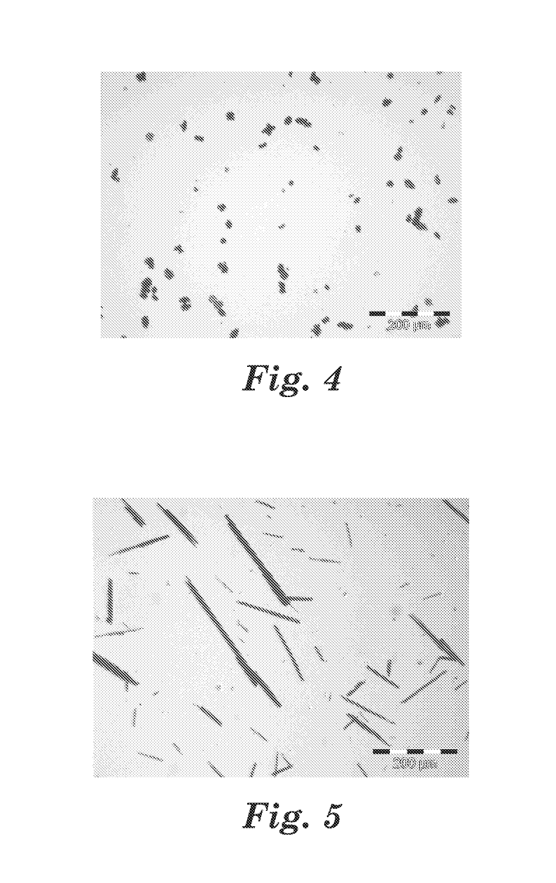

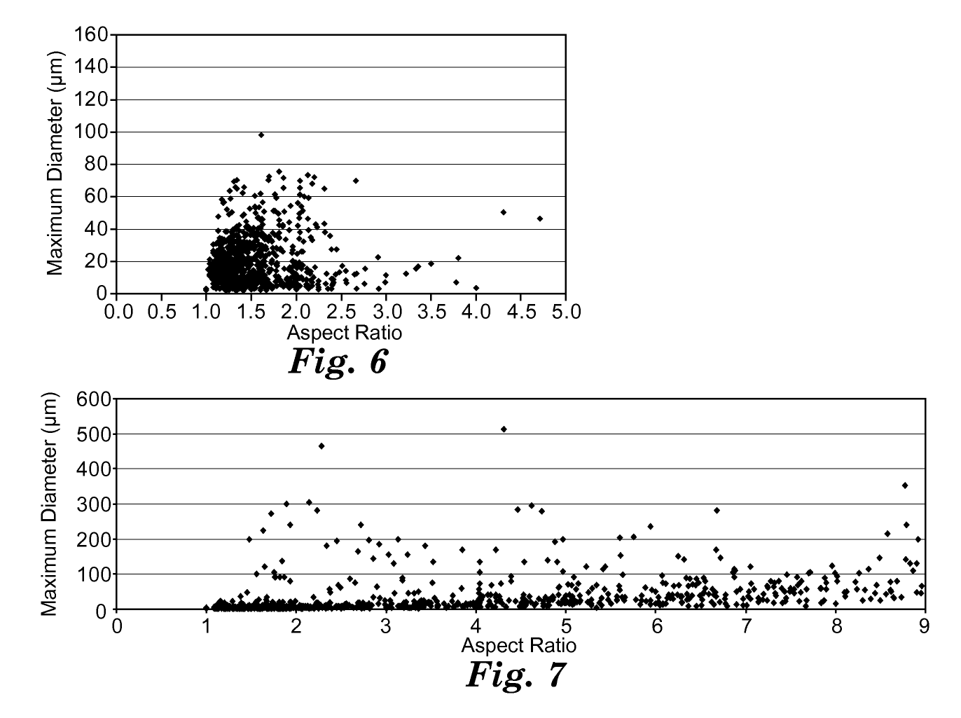

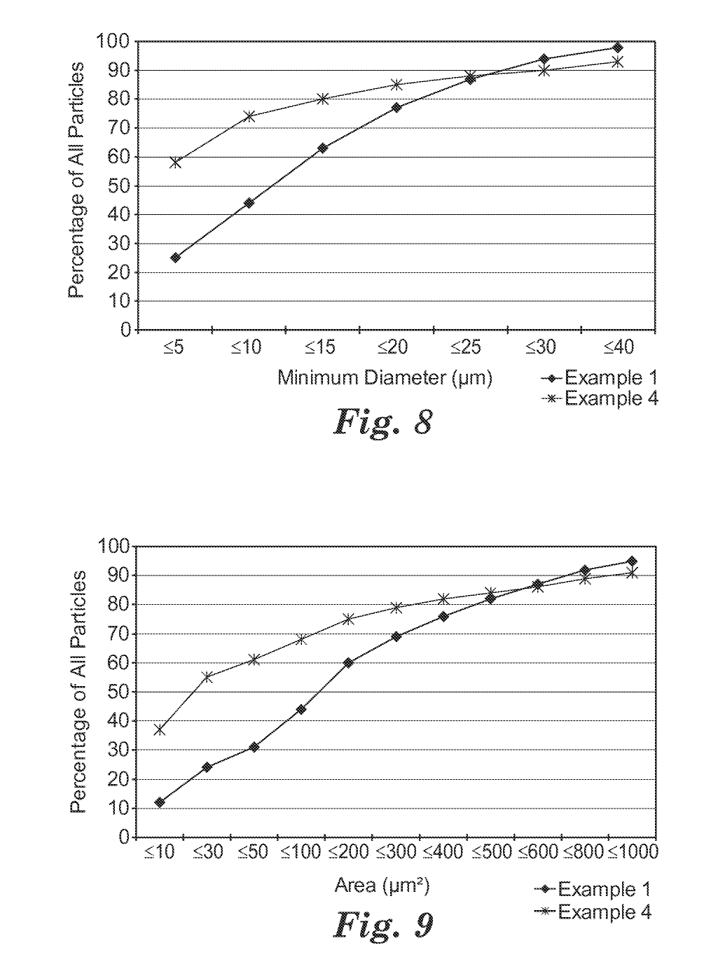

The particles produced are squared or globular-like crystals. They were analyzed using optical microscopy in accordance to the test method described above. FIG. 4 shows an image of the quinhydrone dispersion. FIG. 6 provides a plot of aspect ratio versus maximum diameter. 97% of the particles have an aspect ratio of 2.5 or less; and a majority of the particles have an aspect ratio of less than 1.5.99% of all particles have a maximum diameter equal to or less than 80 μm and 90% of all particles have a maximum diameter equal to or less than 40 μm. FIGS. 8 and 9 provide plots (shown as -♦-) of minimum diameter and area distributions, respectively. 75% and 56% of all particles have a minimum diameter greater than 5 μm & 10 μm, respectively. 56% of all particles have an area greater than 100 μm², and 76% of all particles have an area equal to or less than 400 μm² (i.e. only 24% or less have an area greater than 400 μm²). 821 particles were analyzed.

### Examples 2 and 3

### Preparation of Sensors

### Example 2

A sensor strip (65×9 mm)—having a tip similar to that illustrated in FIG. 1—was constructed. A polyester film (200 μm thick marketed under the trade name Melinex 329 by Du Pont Teijin Film U.S. Limited Partnership, Hopewell, USA) was used as the substrate. Using a screen-printing process—similar to that illustrated in FIG. 2—a silver-containing ink (marketed under trade designation Electrodag 479SS by Henkel KGaA, Düsseldorf, Germany) was printed on the substrate and cured at 120° C. for 10 min. In a second step a carbon-containing ink (marketed under trade designation Electrodag 423SS by Henkel KGaA, Düsseldorf, Germany) was printed and cured at 120° C. for 10 min. (The connection pads, conductive paths, conductive electrode bases (each base had of a size of about 1.5 by 1.5 mm and a median thickness of about 10 μm) as well as the thermocouples were thus formed.) Ag/AgCl-containing ink (marketed under trade designation 5874 by Du Pont Ltd., Bristol, United Kingdom) was printed onto its appropriate silver-containing conductive electrode base and cured at 120° C. for 10 min, thus forming the reference electrode (having a size of about 1.5×1.5 mm square and a total median thickness of about 20 μm). The substrate—excluding the connection pads and the relevant portions of reference electrode and the conductive electrode base for the working electrode—was then over-coated (using screen printing) with a dielectric material (marketed under trade designation Electrodag PD-039A by Henkel) and UV cured (the layer had a median thickness of about 10 μm). A circular area (diameter of about 0.6 mm) was left uncoated at the reference electrode and the conductive electrode base for the working electrode. A drop (approximately 0.1 μL) of quinhydrone ink product from Example 1 was deposited (i.e. dropped) and dried onto its appropriate carbon-containing conductive electrode base, thus forming the working electrode. (The sensing composition over-layer of the working electrode generally had a diameter of about 0.6 mm and a median thickness of 45 μm (the upper portion of the sensing composition over-layer extended over the dielectric layer).

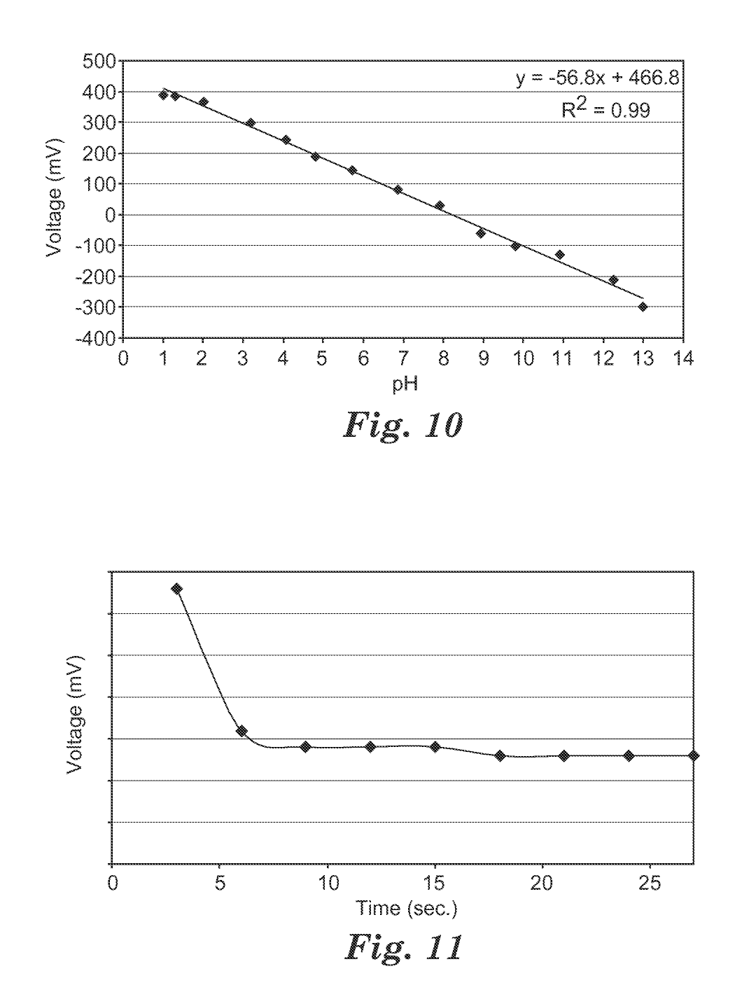

Voltage response of the quinhydrone-containing working electrode of a series of sensors of the type of Example 2 was measured—independent of the printed reference electrode—using a high impedance voltmeter (input resistance: 10¹¹-10¹² Ohm) that was placed between the working electrode and an external, standardized Ag/AgCl reference electrode (marketed under trade designation 6.0750.100 by Metrohm). The voltage response was measured using one sensor for each measurement and recorded over measurements of a series of standard pH buffers. The values obtained 30 sec. after the quinhydrone—containing working electrodes were exposed to the different buffer solutions are plotted in FIG. 10. The voltage response to a pH 6.96 phosphate buffer was measured over a series of time intervals using one sensor for each measured time interval. Response time of quinhydrone electrode is plotted in FIG. 11.

### Example 3

Sensors were prepared like that of Example 2, except prior to application of quinhydrone ink, an atoll was printed onto the protective-dielectric layer using a dielectric material (marketed under trade designation 5015 by DuPont Electronic Technologies) and such that the reference electrode and the carbon-containing conductive electrode base were surrounded. The maximum height of the atoll was 60 μm and the atoll was generally oval in form approximately 4.6 mm in length by 2.8 mm in width.

### Example 4

Example 1 was repeated excepted that the aliquot of Solution 1 added to Solution 2 did not contain hydroxypropylmethylcellulose. In other words there was no hydroxypropylmethylcellulose present during the step of combining benzoquinone and hydroquinone. After quinhydrone had crystallized and was allowed to settle, and the supernatant was removed, Solution 4 containing the aforementioned hydroxypropylmethylcelluloses was added as described in Example 1.

The crystallized particles were analyzed using optical microscopy using the method described above. FIG. 5 shows an image of particles, where needle crystals can be readily identified. FIG. 7 provides a plot of aspect ratio versus maximum diameter, and aspect ratios up to 25 were measured together with maximum diameters up to 500 μm. Nearly 50% of the particles have an aspect ratio equal to or greater than 2.5 and less than 25% have an aspect ratio less than 1.5. FIGS. 8 and 9 provide plots (-*-; Example 4) of minimum diameter and area distributions of this example. 58% of the particles have a minimum diameter equal to or less than 5 μm. 55% of the particles have an area less than 30 μm². Only 32% of all particles have an area greater than 100 μm². 1284 particles were analyzed.

A series of sensors were prepared according to Example 2 using the needle-shaped quinhydrone-hydroxypropylmethylcellulose containing ink of this Example (i.e. Example 4).

A series of sensors were made according to Example 2, i.e. using the squared/globular-like crystalline quinhydrone-hydroxypropylmethylcellulose containing ink of Example 1.

Voltage responses of freshly made quinhydrone-containing working electrodes (measured as described in Example 2) were similar: Example 2 had a slope of −63 mV/pH and Example 4-58 mV/pH. Also the response times for both were similar. The results demonstrate the advantages of a depth electrode as described herein (i.e. a working electrode formed at least in part of a sensing comprising quinhydrone and at least one water soluble derivative of a polysaccharide).

Voltage responses of quinhydrone-containing working electrodes were measured upon accelerated aging (80° C. over a period of 150 minutes measuring at intervals of 30 minutes.). The results are summarized in the following table

TABLE 1

| | mV/pH-slope of | Response |
|---|---|---|
| Sensor-type | 30 sec. potential value | (mV) in pH 5.09 |
| Example 2 | −63 +/− 0.8 mV/pH | 189 +/− 2 mV |
| Example 4 | −58 → −52 mV/pH* | 175 → 156 mV* |

*Slope and potential of Example 4 continuously dropped and at different rates.

The results demonstrate the advantages of using novel crystalline quinhydrone materials described herein.

### Reference Examples 5 and 6

### Reference Example 5

1.5 g of quinhydrone (obtained directly from Fluka (No. 22950)) was mixed and dissolved in 100 g of ethanol. A series of reference sensors were made according to method described in Example 2 except the aforesaid-prepared solution was used as the quinhydrone ink. After depositing the drop of quinhydrone-ethanol solution, the solution was dried, and long, thin needles formed on the carbon-conductive electrode base upon drying.

### Reference Example 6

2.16 g of quinhydrone (obtained directly from Fluka (No. 22950)*) was mixed into 20 g of carbon-containing ink composition (marketed under trade designation Electrodag 423 SS by Acheson Inc., Michigan, USA and now by Henkel KGaA, Düsseldorf, Germany.). A series of reference sensors were made according to method described in Example 2 except the aforesaid-prepared quinhydrone-carbon composition was used as the quinhydrone ink. After depositing the drop on quinhydrone-carbon composition ink, the composition was cured at 120° C. for 5 minute.

*Optical microscopy of the quinhydrone obtained directly from Fluka revealed that the material included particles that can be described as dust together with large broken bits and pieces of needles. Around 25% of the particles have an aspect ratio greater than 2.5; less than 33% of the particles have an aspect ratio less than 1.5; 51% of the particles have a minimum diameter equal to or less than 5 μm; 50% of the particles have an area less than 30 μm²; 28% of the particles have an area greater than 100 μm². (Sample preparation for analysis: 1.5 g of the powder-sample was added under stirring to 100 g of a 5.5% aqueous solution of cellulose ether (5% Methocel E 15 LV and 0.5% Methocel 311. 813 particles were analyzed.)

Reproducibility within a Series of Sensors Made with One Batch of Quinhydrone Ink

A series of sensors were made according to Example 2.

Voltage response of the quinhydrone-containing working electrode was measured over the series of sensors. The results are summarized in the following table:

TABLE 2

| | mV/pH-slope of 30 | | | |
|---|---|---|---|---|
| Sensor-type series | sec. potential value* | | Response (mV) in pH 6.96 | |
| Example 2 | stable | −57 +/− 0.9 | stable | 80 +/− 2 mV |
| | | mV/pH** | | |
| Ref. Example 5 | erratic | −50 +/− 10 | erratic | 48 +/− 4 mV |
| | | mV/pH | | |
| Ref. Example 6 | very | −15 +/− 41 | extremely | 103 +/− 45 mV |
| | erratic | mV/pH | erratic | |
| Ref. Example 6 | | −54 +/− 16 | | 52 +/− 24 mV |
| surface | | mV/pH | | |
| scraped*** | | | | |

*The theoretical slope - mV per pH - of a quinhydrone-pH sensing working electrode is −59 mV/pH.
**More than 30 series of working electrodes prepared by providing novel crystalline quinhydrone-sensing composition over-layers (as described herein) showed slopes from −55 to −63 mV/pH with a stability within one series of about +/−1 mV/pH
***Using a microscope the top surface of the working electrode of a number of reference-example-6-sensors were ground (prior to testing) with a bit of super fine sandpaper (ISO P1200) in an attempt to remove the very top skin from the electrode.

### Examples 7 and 8

Example 1 was repeated except that the following methyl or hydroxylpropyl-methylcellulose was used in Solution 1 instead of the given hydroxylpropylmethylcellulose:

### Example 7

Methylcellulose marketed under the trade designation METHOCEL A15 Premium LV by the Dow Chemical Company, Wilmington, Del., USA (methoxy content 27.5-31.5%, hydroxypropyl content 0%; viscosity of 2% solution in water 12-18 mPa·s); and

### Example 8

Hydroxylpropylmethylcellulose marketed under the trade designation METHOCEL K100 Premium LV by the Dow Chemical Company, Wilmington, Del., USA (methoxy content 19-24%, hydroxypropyl content 7-12%; viscosity of 2% solution in water 80-120 mPa·s).

In each case the resulting product included crystalline quinhydrone particles like that of Example 1 with a squared and globular form and thus corresponding aspect ratios, diameters, and area.

### References Examples 9 to 13

The repetition of Example 1 using the following materials in Solution 1 instead of the given hydroxylpropylmethylcellulose yielded needles (the first four listed materials) or feathery-agglomerates (last listed material):

### Reference Example 9

dextrose (available under the designation D-(+)-Glucose, dextrosum or glucosum anhydricum acc. to Pharmacopoea Europaea from Fluka) needles up to 300 microns long

### Reference Example 10

starch (available under the designation potato starch, solani amylum acc. to Pharmacopoea Europaea from Fluka) needles up to 500 microns long;

### Reference Example 11

Fatty alcohol polyglycol ether (marketed under the trade designation DISPONIL Ls 9,5 by Cognis GmbH, Monheim am Rhein, Germany) needles up to 350 microns long;

### Reference Example 12

Polyethylene glycol 35000 (available from Fluka, mp: 64-66° C., Rel. Molecular Mass: 35000) needles between 100 and 200 microns long; and

### Reference Example 13

Polyvinylalcohol (marketed under the trade designation MOWIOL 26-88 by Kuraray Europe GmbH, Frankfurt am Main, Germany), viscosity of a 4% aqueous solution at 20° C.: 24.5-27.5 mPa·s, degree of hydrolysis: 86.7-88.7 Mol.-%, ester number: 130-159 mg KOH/g) feathery-agglomerates.

1-40. (canceled)

41. A method of preparing crystalline quinhydrone for use in or as a quinhydrone ink in the manufacturing of a sensor, said method comprising a step of:
combining aqueous solutions of benzoquinone and hydroquinone in the presence of at least one additive, wherein the concentrations of the aqueous solutions of benzoquinone and hydroquinone are such that the concentration of quinhydrone formed upon said combining exceeds the solubility of quinhydrone at the temperature at which said combining is performed and wherein said at least one additive is at least one water soluble derivative of a polysaccharide.

42. A method according to claim 41, wherein the aqueous solutions of benzonquinone and hydroquinone are independently saturated or nearly saturated.

43. A method according to claim 41, wherein the aqueous solutions of benzoquinone and hydroquinone are equimolar or nearly equimolar.

44. A method according to claim 41, wherein prior to the step of combining, the method comprises either forming an aqueous solution of benzoquinone containing said at least one additive and forming an aqueous solution of hydroquinone, or forming an aqueous solution of hydroquinone containing said at least one additive and forming an aqueous solution of benzoquinone.

45. A method according to claim 41, wherein prior to the step of combining, the method comprises forming an aqueous solution of benzoquinone containing said at least one additive and forming an aqueous solution of hydroquinone, and the step of combining includes adding the aqueous solution of hydroquinone to the aqueous solution of benzoquinone containing said at least one additive.

46. A method according to claim 41, wherein the initial concentration of the at least one additive is provided such that upon completion of the step of combining the weight by weight concentration of said at least one additive is at least 0.1% and the initial concentration of the at least one additive is provided such that upon completion of the step of combining the weight by weight concentration of said at least one additive is at most 10%.

47. A method according to claim 41, wherein the at least one additive is at least one water soluble ester or ether derivative of a polysaccharide, in particular at least one water soluble ester or ether cellulose, more particularly at least one a water soluble ether cellulose, most particularly at least one a water soluble ether cellulose selected from the group consisting of sodium carboxymethylcellulose (CMC), hydroxyethylcellulose (HEC), carboxymethylhydroxyethylcellulose (CMHEC), hydroxypropylcellulose (HPC), methylcellulose (MC), hydroxypropylmethylcellulose (HPMC), hydroxybutylmethylcellulose (HBMC), hydroxyethylmethylcellulose (HEMC), ethylcellulose (EC), ethylhydroxyethylcellulose (EHEC, HEEC), dihydroxypropylcellulose, hydroxyethylhydroxypropylcellulose, and mixtures thereof.

48. A method according to claim 41, wherein the combining is performed at a temperature equal to or less than 45° C. and the combining is performed at a temperature equal to or greater than 5° C.

49. A method of preparing a quinhydrone ink for use in the manufacturing of a sensor, said method comprising the steps of:
providing crystalline quinhydrone according to claim 41;
allowing the crystalline quinhydrone to sediment;
removing part or all of the supernatant;
adding a liquid to the sediment; and
dispersing the sediment in said liquid.

50. A method according to claim 49, wherein the liquid is water or a water/solvent mixture.

51. A method according to claim 49, wherein the liquid comprises at least one modifier, in particular the liquid is an aqueous solution comprising at least one modifier.

52. A method according to claim 51, wherein said at least one modifier is at least one water soluble derivative of a polysaccharide.

53. A method according to claim 53, wherein said at least on modifier is at least one water soluble ether cellulose selected from the group consisting of sodium carboxymethylcellulose (CMC), hydroxyethylcellulose (HEC), carboxymethylhydroxyethylcellulose (CMHEC), hydroxypropylcellulose (HPC), methylcellulose (MC), hydroxypropylmethylcellulose (HPMC), hydroxybutylmethylcellulose (HBMC), hydroxyethylmethylcellulose (HEMC), ethylcellulose (EC), ethylhydroxyethylcellulose (EHEC, HEEC), dihydroxypropylcellulose, hydroxyethylhydroxypropylcellulose, and mixtures thereof.

54. A method according to any one of claim 49 comprising a further step of adding a conductive component, said step being performed at least subsequent to the step of providing crystalline quinhydrone.

55. A method of preparing a sensor, said sensor comprising a substrate provided with at least one conductive path, said method comprising a step of forming a working electrode comprises depositing and drying a product of a method according to claim 41 onto a conductive electrode base that is provided on the substrate and in electrical contact with said conductive path.

56. A method of preparing a sensor, said sensor comprising a substrate provided with at least one conductive path, said method comprising a step of forming a working electrode comprises depositing and drying a product of a method according to claim 55 onto the substrate such that the formed working electrode is in electrical contact with said conductive path provided on the substrate.
